(19) United States
(12) Patent Application Publication
(10) Pub. No.: US 2026/0074095 A1
(43) Pub. Date: Mar. 12, 2026

(54) Electrical feedthrough and method for its production

(71) Applicant: SCHOTT AG, Mainz (DE)

(72) Inventor: Helmut HARTL, Vienna (AT)

(21) Appl. No.: 19/305,882

(22) Filed: Aug. 21, 2025

(30) Foreign Application Priority Data
Sep. 6, 2024 (DE) 102024125574.9

(51) Int. Cl. H01B 17/30; H01B 1/02; H01B 3/08; H01B 13/22; H01B 19/04

(52) U.S. Cl. CPC H01B 17/301; H01B 1/02; H01B 3/08; H01B 13/222; H01B 19/04

(57) ABSTRACT

An electrical feedthrough includes a base body with a sealing region, at least one opening and an electrical conductor fed through the opening, wherein the conductor is held in the opening by a fixing material and the fixing material seals the opening. The edges which surround the opening are designed to be sharp and all edges of an outer contour of the base body are provided with a chamfer or a rounding, which has a size or a radius r in the range of 0.3 mm to 2 mm.

This claims priority to German patent application DE 10 2024 125 574.9, filed on Sep. 6, 2024 which is hereby incorporated by reference herein.

The present invention relates to an electrical feedthrough comprising a base body with at least one opening and an electrical conductor fed through the opening.

### BACKGROUND

Housings for electrical or electronic components generally require a plurality of electrical feedthroughs to enable electrical connections from the outside into the interior of the housing in which, for example, parts of an electric compressor (e-compressor) are located. The electrical feedthroughs must be liquid-tight or even hermetically sealed in order to protect the components in the housing from the environment and/or to keep gases or liquids in the interior of the housing. In order to obtain such liquid-tight or hermetic feedthroughs for an electrical conductor which is arranged in an opening of the housing, glass-metal feedthroughs may be used. A fixing material, for example a glass material, is used here to seal the opening and to hold the conductor in the opening. The fixing material also ensures electrical insulation between the conductor and the housing.

In the case of the known feedthroughs, a substantially plate-shaped element forms a base body through which the electrical conductors are fed. This base body may then in turn be inserted into an opening of a housing of an electric or electronic device, for example an e-compressor. In order to ensure sealing between the base body and the housing, sealing faces on the base body must be smooth and even.

WO2021070817A1 discloses an electrical feedthrough, in which an outer conductor or a base body has frame-like or beam-like extension portions as a reinforcing structure. This may surround the entire outer conductor or be arranged only on longitudinal sides of a plate-shaped base body.

### SUMMARY OF THE INVENTION

To produce the frame-like or beam-like extension portions, an initially plate-shaped base body is punched out of a strip material and then formed via a multi-stage drawing process, for example by deep drawing. The edges of the base body that are produced during the punching procedure are sharp and have a radius of less than 0.3 mm. If the base bodies are processed as bulk goods, which means that they can knock against one another, the sealing faces may become damaged by these sharp edges so that they are no longer smooth and suitable for use as a sealing face.

However, it would be desirable for the base body or a plurality of base bodies to be handled as bulk goods to enable simple and efficient production processes during the manufacture of the electrical feedthrough.

An object of the present invention is to provide an electrical feedthrough in which the base body may be processed as bulk goods without damaging sealing faces and which therefore simplifies the production of the electrical feedthrough.

An electrical feedthrough is proposed, which comprises a base body with a sealing region, at least one opening and an electrical conductor fed through the opening, wherein the conductor is held in the opening by a fixing material and the fixing material seals the opening. It is provided here that edges which surround the opening are designed to be sharp and all edges of an outer contour of the base body are provided with a chamfer or a rounding, which has a size or a radius r in the range of 0.3 mm to 2 mm, preferably in the range of 0.5 mm to 1.5 mm, particularly preferably 0.75 mm to 1.0 mm.

The base body is preferably configured to be plate-shaped with a substantially rectangular basic form. The longitudinal side, and therefore the longitudinal edges, of the base body are preferably linear here. The transverse side of the base body may likewise have a linear design; however, curved forms and combinations of linear and curved portions are also possible. By way of example, the transverse side may have a curved form whereof the radius corresponds to substantially half the width B/2 of the base body. Furthermore, it is possible to provide a linear portion in the centre with curved transitions to the longitudinal sides. A further example is a curved portion in the centre of the transverse side, which merges into the longitudinal side via two short linear portions or chamfers.

A side ratio L/B of the longest side L to the width B of the base body is preferably in the range of 1.5 to 10, particularly preferably in the range of 2 to 5. Greater side ratios enable the arrangement of more conductors fed through next to one another in the same electrical feedthrough.

The base body preferably has a vertical edge, wherein the edge or the face of the edge encloses an angle of substantially 90° with the top side and the bottom side of the base body. The expression “substantially” here also covers manufacturing tolerances, in particular deviations within an angle of +/−5°.

The chamfer or rounding provided is present at least on the edges of the outer contour of the base body. The edges of the outer contour in the case of a substantially rectangular base body are those edges which form the transition between the top side or the bottom side and the vertical edge. In the case of a rounding, the corresponding edge is provided with a radius which is in the range of 0.3 mm to 2 mm, preferably in the range of 0.5 mm to 1.5 mm, particularly preferably 0.75 mm to 1.0 mm. In the case of a chamfer, a stepped transition between the top side or the bottom side and the vertical edge is created, wherein, instead of an angle of ca. 90°, the transition is realized in at least two steps of less than 90° in each case-these steps being, for example, 45° in each case or, for example, 30° and 60°. The size of the chamfer here is the spacing between these two steps, wherein the size is in the range of 0.3 mm to 2 mm, preferably in the range of 0.5 mm to 1.5 mm, particularly preferably 0.75 mm to 1.0 mm.

The base body of the feedthrough preferably comprises multiple openings through which an electrical conductor is fed in each case and held by the fixing material. The fixing material acts as a seal with respect to the wall of the opening and the conductor. The feedthrough preferably has between two and five conductors fed through it, for example precisely three electrical conductors are fed through it. As an alternative to this, however, the feedthrough may also have precisely one electrical conductor fed through it.

The base body may comprise further openings, which serve as fastening openings. The feedthrough may be fastened to a housing part through the fastening openings, for example via screws.

At least the openings through which an electrical conductor is fed and held by the fixing material have a sharp edge at the transition from an inner wall of the opening to the surfaces of the top side and the bottom side of the base body. In particular, an edge is regarded as sharp if it is not provided with a rounding or with a chamfer or if it does not have a rounding or chamfer which has a radius or a size of less than 0.3 mm, particularly preferably of less than 0.2 mm and most preferably of less than 0.1 mm. Since an abrupt, perfectly sharp transition cannot be realized in practice, the radius of the sharp edge is generally more than 50 nm. The sharp edges of the opening can be generated, for example, by punching.

Sharp edges at the transition to the inner walls of the opening have the advantage that the fixing material and the inner wall abut against one another at a linear vertical wall. In the case of a rounding or a chamfer, the wall would curve away from the fixing material in the region of the upper termination of the fixing material and therefore weaken a connection between them. In the event of a mechanical load, parts of the fixing material might peel off in this region and weaken the feedthrough as a whole or cause it to leak.

Furthermore, one or more notches may be arranged along the outer edge or outer contour of the base body. These notches enable clear orientation for a base body which is otherwise configured to be symmetrical along one or more points or along one or more planes. In particular, this enables the top side of the base body to be distinguishable from its bottom side. During the punching processes, a difference between the top side and the bottom side of a component is normally evident through a slight curvature or arching, wherein, for example, the top side may be slightly convexly arched and the bottom side may be slightly concavely arched. For installing the feedthrough in a housing, one of the orientations may be more advantageous than the other here.

A sealing region is provided on the top-side and/or on the bottom side of the base body of the feedthrough, which sealing region is substantially smooth and even and is, in particular, free of notches and scratches. Over this sealing region, a sealing element, for example an O-ring, may form a seal against the sealing region of the base body and a sealing region on the housing. Furthermore, the sealing region of the base body is preferably configured to be even, wherein the sealing region preferably has a deviation in the evenness of ≤0.1 mm according to DIN EN ISO 1101, as of 09/2017, in particular in the range of 0.005 mm to 0.02 mm per 10 mm length.

The base body is preferably provided with a surface plating. The resistance of the material of the base body, in particular to corrosive environmental influences, may be increased by the plating.

The surface plating is preferably a nickel coating, which may be electrodeposited or chemically deposited on the surface of the metal material of the base body. In the case of electroplating, the plating is preferably obtained by barrel plating. The plating is preferably arranged on the entire surface of the base body and is preferably free of gaps or defects.

The base body is preferably manufactured from metal, wherein the metal is preferably selected from the group comprising steel, in particular unalloyed steel such as a steel with material number 1.0338 or stainless steel, NiFe, Kovar, titanium and copper.

Metal parts, in particular formed metal parts, have a fiber-like grain structure, which is referred to as fiber orientation or metallurgical flow lines. The fiber orientation (grain orientation) may be made visible, for example, along a section through the metal part via a wet chemical etching process. The fiber orientation-and, in particular, the direction thereof-is influenced by forming processes such as deep drawing.

Since the metal material has its greatest mechanical stability parallel to the fiber orientation, provision is made to align the longest side of the base body, which is therefore at the greatest risk of warping or bending, parallel to the fiber orientation. As a result, the flexural stiffness along the longest direction of the base body is improved without additional material usage.

The base body is preferably manufactured from a wire profile, which may be obtained by rolling a wire. In the case of a wire material, the fiber orientation is aligned in the direction of the wire as a result of the wire drawing process. By rolling the wire, the cross-sectional form of the wire material may be adapted without altering the fundamental alignment of the fiber orientation. The base body is preferably obtained from a wire profile, the cross section of which has a height which corresponds to the thickness of the base body and a width which corresponds to the width of the base body. By cutting a piece with a length which corresponds to the length of the base body, the base body with length L, width B and thickness D is obtained. Since the long side is aligned in the wire drawing direction of the wire profile, the fiber orientation is thus parallel to the long side of the base body.

Since the base body is cut from the wire profile with the width B on its shorter side, a significantly shorter cutting or punching length is achieved compared to cutting out of a plate or cutting along the long longitudinal side with the length L. This enables the base body to be produced using a relatively small punching machine and with reduced tool costs.

The electrical conductor is made of an electrically conductive conductor material, for example a metal. The at least one electrical conductor is preferably made of a conductor material which is selected from the group which comprises steel, in particular stainless steel, a nickel-iron alloy and copper. Moreover, the conductor may have a core made of a highly-conductive material, for example copper, and another material as an outer sheath.

The fixing material is preferably a glass material or a glass-ceramic material. The electrical conductor is held in the opening of the base body, and electrically insulated with respect to the base body, via the fixing material. Furthermore, the fixing material seals the opening towards the inner wall of the opening and the electrical conductor.

The base body, the at least one conductor and the fixing material preferably form a glass-metal feedthrough in the form of a compression glass seal. Accordingly, a first thermal expansion coefficient of the base body is preferably selected to be greater than a second thermal expansion coefficient of the fixing material. In order to obtain a compression glass seal, the difference between the first and the second thermal expansion coefficients in the temperature range of 300 K to 600 K should preferably be at least 2 ppm/K and further preferably at least 5 ppm/K. A third thermal expansion coefficient of the conductor material of the electrical conductor is preferably selected such that it is approximately equal to or smaller than the second thermal expansion coefficient of the fixing material. Two thermal expansion coefficients are regarded as approximately equal if the difference is less than 2 ppm/K.

In connection with the design of the feedthrough as a compression glass feedthrough, in which the fixing material is under compressive pressure from the base body, the alignment of the fiber orientation or the metallurgical flow lines parallel to the longitudinal side with the length L has an advantageous effect since this achieves a particularly high strength with a low material consumption and relatively small size.

As an alternative to a compression glass seal, the material of the base body, the fixing material and the conductor material may be selected such that their respective thermal expansion coefficients are approximately equal, wherein a difference of less than 2 ppm/K is regarded as approximately equal. In this variant, the base body, the at least one conductor and the fixing material form an adapted glass-metal feedthrough.

The glass-metal feedthrough formed is preferably hermetically sealed, wherein a feedthrough with a He leakage rate of less than 1×10⁻⁷ mbar I/s, preferably less than 1×10⁻⁸ mbar I/s at a pressure difference of 1 bar is regarded as hermetically sealed.

The base body preferably has a reinforcing structure at least on the edges of the longitudinal side, wherein the reinforcing structure is preferably designed as a raised edge region, which is offset vertically with respect to a base plane of the base body.

The raised edge region is preferably offset vertically with respect to a base plane of the base body, wherein a thickness S1 of the edge region corresponds to a thickness D of the base body. To this end, the raised edge region may be formed by shear forming. As a result, a connecting point or an attachment region between the raised edge region and the rest of the base body has a height smaller than the thickness of the base body.

The base body is preferably made of a metal material, wherein the raised edge region has been obtained from a flat blank by shear forming. The base plane here is, in particular, a plane which is spanned by the longitudinal direction and transverse direction or is oriented perpendicularly to an axis of the openings in the base body and adjoins the edge region. Accordingly, material of the base body is displaced perpendicularly to the base plane as a result of the vertical offset.

As a result of the vertical displacement or the shear forming procedure for obtaining the raised edge region, a fiber orientation of the metal material of the base body is compacted at the connecting point and separated above or below the connecting point.

In the case of a substantially rectangular base body, the raised edge region is preferably arranged at least on the edges of the longitudinal sides, wherein the edge region here may be arranged over the entire length of the longitudinal side. However, the edge region may also be interrupted and/or it may be arranged on only part of the longitudinal sides. Furthermore, the raised edge region may also be arranged on the transverse sides, wherein the raised edge may in turn be arranged over the entire length of the transverse side, although it may also be interrupted and/or it may be arranged on only part of the transverse side. The raised edge region is preferably arranged around the whole outer contour of the base body, like a reinforcing ring. As an alternative to a rectangular basic form, the base body may have, for example, a circular form, wherein the raised edge region then extends preferably annularly around the whole outer contour of the base body.

As a result of the vertical displacement of the material to obtain the raised edge region, a complementary step is produced at the bottom side of the base body. This step may serve as a mechanical stop or as a centring aid when the feedthrough with the base body is inserted into an opening of a housing. The relative position of the electrical feedthrough with respect to the housing may thus be established more precisely and the installation of the electrical feedthrough is facilitated.

The raised edge region forms a wall on the top side of the base body. This may serve as a mechanical stop or as a centring aid for an additional insulation element, which is seated on the electrical feedthrough. Such an additional insulation element, which is manufactured, for example, from an elastic material or a thermoplastic or thermosetting plastic, may be used to extend an insulation path or creepage path between one of the electrical conductors which are fed through and the base body of the feedthrough.

A raised or recessed reinforcing region is preferably formed around the at least one opening, wherein the raised or recessed reinforcing region is offset vertically with respect to a base plane of the base body and wherein a thickness of the raised or recessed reinforcing region corresponds to a thickness of the base body. The reinforcing region, like the edge region, may be obtained by shear forming.

If the base body has more than one opening, a respective suitable raised or recessed reinforcing region may be provided for each of the openings. As an alternative to this, a single raised or recessed reinforcing region may be provided, which encompasses all openings for feeding through an electrical conductor. The fastening openings, where present, may be located outside the raised or recessed reinforcing region here.

Since the edge region and possibly the reinforcing region are obtained merely through vertical displacement of the material of the base body with respect to a base plane of the base body, no additional material is needed to form these regions. The quantity of material corresponds precisely to that of a flat base body with the same dimensions in length and width in the case of a rectangular basic form or diameter in the case of a circular basic form. The mechanical stability of the base body is nevertheless increased and, in particular, the resistance of the base body to bending is enhanced.

The edges produced by the vertical displacement are then at least rounded or provided with a chamfer when these edges are part of the outer contour.

All edges of the base body which do not surround an opening around the base body are provided with a rounding or a chamfer.

In particular, during the production via shear forming, the raised edge region and/or the raised or recessed reinforcing region is offset by less than the thickness D of the base body with respect to a base plane of the base body. The base plane here is the original plane on the surface of the plate-shaped base body or a blank of the base body which is present before carrying out the forming procedure, and, after the shear forming procedure, this base plane corresponds to the plane which adjoins the raised edge region.

The raised edge region and/or the raised or recessed reinforcing region is preferably offset in the range of 20 % to 80 % in the vertical direction in relation to the thickness D of the base body.

The base body may then be obtained from a flat blank by shear forming, wherein the blank has the thickness D and already has the length and width or diameter of the finished base body. A surface of the blank may then be regarded as the base plane. The edge region and/or the reinforcing region may then be obtained through vertical displacement with respect to the base plane of the blank.

Since the raised edge region and/or the reinforcing region are obtained through the vertical displacement of material of the blank, the base body has the same constant thickness D over all regions, i.e. the edge region, the reinforcing region and an unprocessed base region. No additional material is needed to form the edge region and/or the reinforcing region.

The electrical feedthroughs described herein are suitable, in particular, for compressors. The electrical feedthroughs here are particularly suitable for applications in electrically driven compressors, so-called e-compressors, which are used to cool the interior of electrically driven vehicles.

Accordingly, the electrical feedthrough is preferably designed as a connection terminal for an e-compressor.

A further aspect of the present invention is the provision of a method for producing the electrical feedthroughs described herein. Accordingly, features described within the context of the electrical feedthrough apply to the method and, conversely, features described within the context of the method applied to the electrical feedthroughs.

A method for producing one of the electrical feedthroughs described herein comprises forming a base body with at least one opening from a blank, wherein edges which surround the opening are designed to be sharp and at least the edges of an outer contour of the base body are provided with a chamfer or a rounding, which has a radius r in the range of 0.3 mm to 2 mm. Subsequently, a fixing material blank and a conductor are inserted into in at least one of the openings and a heat treatment is carried out to form the fixing material from the fixing material blank.

The generation of the openings and the incorporation of the fibers and/or roundings on the edges are preferably carried out in a common operating step. This may be a combined punching and embossing procedure, for example.

In a variant of the method, the base body is formed from a wire material. The wire material here is rolled into a cross-sectional form in which the dimensions of a long side correspond to the width B of a transverse side of the base body and the dimensions of a short side correspond to the thickness D of the base body. The forming of the base body comprises the separation of a blank from the wire material, wherein a length of a longitudinal side of the blank corresponds to the length L of the longitudinal side of the base body, wherein the wire material is already provided with a rounding with radius r on its edges before the separation of the blank. This rounding forms a rounding along the edges on the longitudinal sides of the base body after the separation procedure. The separation of the blank may take place in a single operating step together with the punching of the openings.

A raised edge region for reinforcing the flexural stiffness of the base body is preferably produced by shear forming.

After it has obtained its final form, i.e. before inserting the fixing material blank and the conductor and carrying out the heat treatment, the base body is preferably electroplated with nickel using a barrel plating technique.

In barrel plating, a conductive barrel establishes electrical contact with the base bodies to be plated. The base bodies here, together with the electrolytes, are located in the barrel, which rotates so that all surfaces are gradually uniformly plated.

This takes advantage of the fact that the base bodies each have exclusively rounded edges, or edges provided with chamfers, on the outer contours. The base bodies in the barrel are each in electrical contact with the barrel or with adjacent base bodies so that they may be electroplated. Upon rotation of the barrel, the base bodies move relative to one another and abut against one another, wherein other parts of the base body in each case are exposed to the electrolyte. As a result of the edges being rounded or provided with chamfers, however, the surface of the base bodies remains smooth and free of notches and/or scratches. Sealing faces are therefore maintained.

In contrast to electroless techniques for applying the nickel coating, the electrolytically deposited nickel coating does not contain phosphorous or is free of phosphorous except for impurities. Compared to electroplating techniques, in which the components to be plated are electrically contacted individually by an electrode, the plating is completely closed and has no defects at the electrical contacting site.

### BRIEF DESCRIPTION OF THE DRAWINGS

The present invention will be described in more detail hereinafter with reference to the figures and without limitation thereto. The same reference signs denote identical or similar elements.

In the figures:

FIG. 1 shows a perspective view of a base body with rounded edges of the outer contour;

FIG. 2 shows a sectional view of a base body from the side;

FIG. 3 shows an electrical feedthrough with the base body in a sectional view from the side;

FIG. 4 shows a base body with a reinforcing structure in a sectional view from the side;

FIG. 5 shows a base body with a reinforcing structure and reinforcing regions in a perspective illustration;

FIG. 6 shows a rolled wire material as a starting product; and

FIG. 7 shows a base body obtained from the wire material in a perspective illustration.

### DETAILED DESCRIPTION

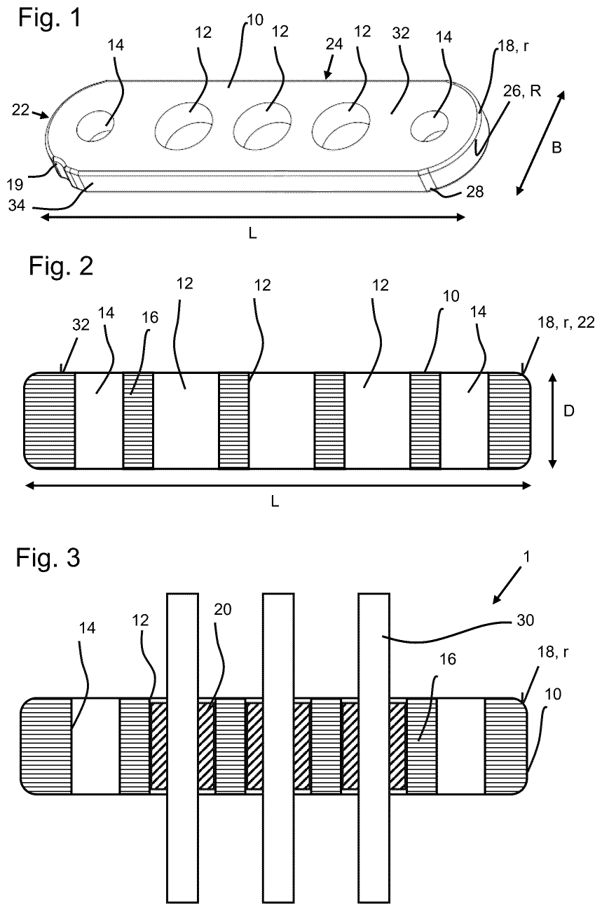

FIG. 1 shows a schematic view of a base body 10 for an electrical feedthrough 1 (c.f. FIG. 3) in a perspective illustration. The form of the base body 10 in the example outlined is substantially rectangular, wherein the long sides 24 are linear with the length L and the short sides 26 are curved with a radius R. A chamfer 28 is formed at the transition between the short sides 26 and the long sides. The base body 10 has a width B.

For feeding through electrical conductors 30 (c.f. FIG. 3), three openings 12 are provided in the example shown in FIG. 1. In addition, the base body 10 outlined in FIG. 1 has two fastening openings 14, via which this base body may be screwed to a housing, for example.

The base body 10 has a vertical edge 34, wherein the vertical edge 34 or the face of the vertical edge 34 encloses an angle of substantially 90° with the top side 32 and the bottom side of the base body 10.

As revealed in FIG. 1, a rounding 18 with radius r is arranged along an outer contour which forms the transition between the top side 32 or the bottom side and the vertical edge 34. On the other hand, the contours which form a transition between the top side 32 or the bottom side of the base body 10 and inner walls of the openings 12 and the fastening openings 14 are designed to be sharp.

To eliminate symmetry, a notch 19 is arranged at one point of the outer contour of the base body 10. By eliminating the symmetry, the top side 32 and the bottom side of the base body 10 can be more easily differentiated.

FIG. 2 shows a sectional view of the base body 10 shown in FIG. 1 from the side. It is clear from this illustration that the outer contour is provided with the rounding 18 with radius r, whilst transitions from the top side 32 or the bottom side of the base body 10 to the inner walls of the openings 12 and the fastening openings 14 are designed to be sharp. To increase the flexural stiffness, in the example outlined, metallurgical flow lines or a fiber structure 16 of the metal material of the base body 10 are aligned parallel to the longitudinal side 24 of length L.

FIG. 3 shows an electrical feedthrough 1 with the base body 10 described with reference to FIGS. 1 and 2. A conductor 30 is fed through each of the openings 12, which conductor is held in the respective opening 12 by a fixing material 20 in each case. The fixing material 20 here acts as a seal with respect to the conductor 30 and the inner wall of the opening 12.

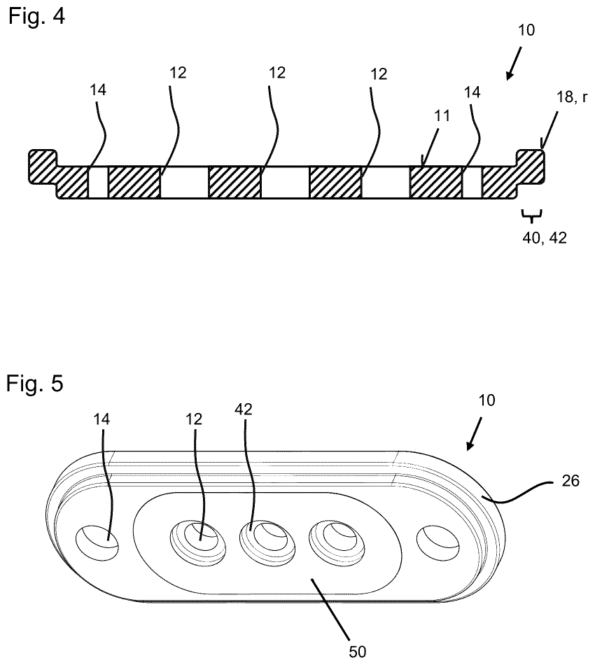

FIGS. 4 and 5 show a second example of a base body 10. Like the base body 10 described with reference to FIGS. 1 and 2, this has three openings 12 for feeding through conductors 30 and two fastening openings 14. The outer contour is again provided with a rounding 18 with radius r. On the other hand, the contours at the transitions to the inner walls of the openings 12 and fastening openings 14 are designed to be sharp.

In contrast to the example of FIGS. 1 and 2, the base body 10 is not of a flat design, but has a reinforcing structure 40 in the form of a raised edge region 42. This raised edge region 42 is displaced vertically with respect to a base plane 11 of the base body 10 by shear forming. At the transition from the base plane 11 to the raised edge region 42, a step is formed, which reinforces the base body 10 against bending.

In FIG. 4, the base body 10 with the raised edge region 42 is shown in a sectional illustration from the side. FIG. 5 shows the base body 10 with the raised edge region in a perspective illustration from below. A sealing region 50 around the openings 12 can be seen on the bottom side in the illustration of FIG. 5.

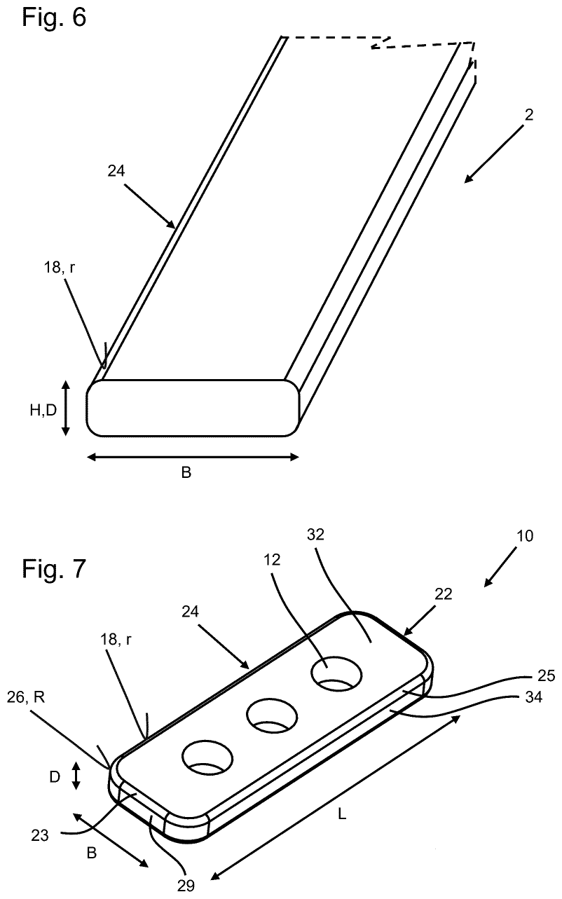

FIG. 6 shows a schematic view of a rolled wire material 2. The wire material 2 has a cross-sectional form which has a length which corresponds to the width B of a transverse side 22 of the base body 10 to be produced (c.f. FIG. 7). A height H of the cross-sectional form of the wire material 2 corresponds to the thickness D of the base body 10 to be produced.

The rolled wire material 2 is obtained, for example, by rolling a round, drawn wire. As a result of the rolling, the cross-sectional form in the form of a rectangle with rounded corners (as illustrated in FIG. 6) is obtained from an original circular cross-section. The rounded corners here represent a rounding 18 of the longitudinal edges 24 of the rolled wire material 2 with a radius r.

FIG. 7 shows a base body 10 with three openings 12 in this example. The base body 10 has a substantially rectangular form with a longitudinal side 24 of length L, a transverse side 22 of width B and a thickness D.

The base body 10 has a vertical edge 34, wherein the vertical edge 34 or the face of the vertical edge 34 encloses an angle of substantially 90° with the top side 32 and the bottom side of the base body 10. At the transitions from the top side 32 or the bottom side of the base body 10 to the vertical edge 34, the base body 10 has edges 23, 25.

The longitudinal sides 24 of the base body 10 are linear, the transverse sides 22 in the example of FIG. 2 are each composed of two curved portions 26 with a radius R and a linear portion 29, wherein the two curved portions 26 are each arranged adjoining the longitudinal side 24.

The base body 10 has been obtained from the wire material 2 shown in FIG. 6 by cutting a blank of length L, incorporating the openings 12 and rounding transverse edges 23. Longitudinal edges 25 here are already rounded before the cutting procedure, since the longitudinal side 24 of the wire material 1 already has corresponding roundings 18. In the exemplary embodiment shown in FIG. 7, the radius r that has been selected for the rounding of the transverse edges 23 is the same as the radius for the rounding of the longitudinal edges 25. However, it goes without saying that it is also possible to select a different radius r′ for the transverse edges 23 or to provide a chamfer instead of a rounding 18.

As a result of providing all edges 23, 25 of the outer contour of the base body 10 with roundings 18, the base body 10 does not have any sharp edges on its outer contour which might damage surfaces of the base body 10 when processing a plurality of base bodies 10 as bulk goods. Therefore, surfaces such as the top side 32 of the base body 10, which may serve, for example, as sealing region 50, remain free of damage such as scratches or notches. Sealing surfaces of the base body 10 remain smooth and free from defects.

On the other hand, edges at the transitions of the walls of the openings 12 to the surface 32 remain free of roundings or chamfers and are therefore sharp edges. This improves the glass bonding of the fixing material 20 (c.f. FIG. 3) to the wall of the opening 12.

Although the present invention has been described with reference to preferred exemplary embodiments, it is not limited thereto, and is modifiable in various ways.

### LIST OF REFERENCE SIGNS

1 Electrical feedthrough
2 Wire material
10 Base body
11 Base plane
12 Opening
14 Fastening opening
16 Metallurgical flow lines / fiber orientation
18 Rounding
19 Notch
20 Fixing material
22 Transverse side
23 Transverse side
24 Longitudinal side
25 Longitudinal edge
26 Curved portion
28 Chamfer
29 Linear portion
30 Conductor
32 Top side
34 Vertical edge
40 Reinforcing structure
42 Raised edge region
50 Sealing region
r Radius, rounding
R Radius, corner/edge
D Thickness, base body
B Width, base body
L Length, base body

1. An electrical feedthrough comprising:
a base body with a sealing region, at least one opening and an electrical conductor fed through the opening, the electrical conductor being held in the opening by a fixing material and the fixing material sealing the opening, edges surrounding the opening being designed to be sharp, all edges of an outer contour of the base body being provided with a chamfer or a rounding having a size or a radius r in the range of 0.3 mm to 2 mm.

2. The electrical feedthrough as recited in claim 1 wherein the base body is provided with a surface plating.

3. The electrical feedthrough as recited in claim 1 wherein the base body is provided with a nickel coating.

4. The electrical feedthrough as recited in claim 1 wherein the base body is provided with an electroplated nickel coating.

5. The electrical feedthrough as recited in claim 1 wherein the base body has a rectangular form, and a side ratio L/B of a longitudinal side of length L to a transverse side of width B of the base body is in the range of 1.5 to 10.

6. The electrical feedthrough as recited in claim 5 wherein the base body is made of a metal material, a fiber orientation of the metal material being aligned parallel to the longitudinal side.

7. The electrical feedthrough as recited in claim 5 wherein the base body has a reinforcing structure at least on the edges of the longitudinal side.

8. The electrical feedthrough as recited in claim 7 wherein the reinforcing structure is designed as a raised edge region offset vertically with respect to a base plane of the base body.

9. The electrical feedthrough as recited in claim 1 wherein a raised or recessed reinforcing region is formed around the at least one opening, wherein the raised or recessed reinforcing region is offset vertically with respect to a base plane of the base body and wherein a thickness of the raised or recessed reinforcing region corresponds to a thickness of the base body.

10. The electrical feedthrough as recited in claim 1 wherein the electrical feedthrough is designed as a connection terminal for an e-compressor.

11. A method for producing an electrical feedthrough, the method comprising:
forming a base body with at least one opening from a blank, edges surrounding the opening being designed to be sharp and edges of an outer contour of the base body being provided with a chamfer or a rounding having a radius r in the range of 0.3 mm to 2 mm;
inserting a fixing material blank and a conductor into at least one of the openings; and
carrying out a heat treatment to form the fixing material from the fixing material blank.

12. The method as recited in claim 11 wherein generation of the openings and the incorporation of the chamfers or roundings on the edges are carried out in a common operating step.

13. The method as recited in claim 11 wherein the base body is formed from a wire material, the wire material having been rolled into a cross-sectional form in which dimensions of a long side correspond to a width B of a transverse side of the base body and dimensions of a short side correspond to a thickness D of the base body, the forming of the base body including separation of a blank from the wire material, wherein a length of a longitudinal side of the blank corresponds to the length L of the longitudinal side of the base body, wherein the wire material is already provided with a wire material rounding with radius r on its edges before the separation of the blank, wherein the wire material rounding forms the rounding along the edges on the longitudinal sides of the base body after the separation procedure.

14. The method as recited in claim 11 wherein, before carrying out the heat treatment, the base body is electroplated with nickel using a barrel plating technique.
